(19) United States
(12) Patent Application Publication
(10) Pub. No.: US 2003/0078939 A1
(43) Pub. Date: Apr. 24, 2003

(54) Method of automatically downloading photos from a web page

(75) Inventor: Car-Lai Ma, Taipei (TW)

Correspondence Address: BACON & THOMAS, PLLC, 625 SLATERS LANE, FOURTH FLOOR, ALEXANDRIA, VA, 22314

(73) Assignee: Tiger Color Inc., Taipei (TW)

(21) Appl. No.: 09/983,455

(22) Filed: Oct. 24, 2001

(51) Int. Cl. G06F 7/00

(52) U.S. Cl. 707/104.1

(57) ABSTRACT

The present invention relates to a method of automatically downloading the photo from a web page, which has a photo collector plugged in a web page browser installed in a computer; when the said browser opens a web page on-line, a photo selection button disposed on the said photo collector is activated to make the said photo collector recognize all the thumbnails on the said web page and available for downloading the photo as well as to respectively generate a click mark on the rim of the said thumbnails for the user to click on the photo to be downloaded according to the need.

### BACKGROUND OF THE INVENTION

1) Field of the Invention

The present invention relates to a download process, more particularly to a method of automatically downloading photos from a web page.

2) Description of the Prior Art

Recently, due to the prosperous development of the network, various types of related equipment have been invented and extensively applied in different businesses; this developing trend not only accelerates the speed and the efficiency of information communication, but also significantly conveniences people's life and work.

Usually, after a computer is on-line with an Internet, through a network browser installed in the said computer, an user can browse numerous contents of pictures and words on the web pages in the world of Internet; the user can also download the interested web page contents through the said network browser and save it in a save equipment of the computer for later access at any time. Traditionally, certain downloading procedures have to be conducted when the network browser is used to download the web page photo from the Internet; taking the Microsoft Internet Explorer for example, the downloading procedure of a traditional Internet browser is described as follows:

1. Referring to FIG. 1 first, the user has to open a web page (20) through an Internet browser (10) and browse a thumbnail (30) displayed on the said web page (20);

2. Then the user uses the left key on a mouse, referring to FIG. 2, to click on a thumbnail (30) of a certain photo to be downloaded;

3. After that, referring to FIG. 3, the Internet browser (10), based on the thumbnail (30) clicked by the user, goes to the storage location corresponding to the photo at the website of the said web page (20) and downloads the request photo (40);

4. After that, referring to FIG. 4, the user presses the right key on the mouse to open the Internet browser (10) and display a drag-down window menu (50) for selecting whether to use “Save As” to save the photo in the save equipment of the computer:

5. Finally, after clicking on “save as” from the drag-down window menu (50), referring to FIG. 5, the user needs to input the document file (60) such as “My Documents” for saving the said photo file (70) in the computer save equipment. It is up to this point that the procedure for saving certain photo of the said web page (20) in the computer is then completely accomplished.

When trying to download the other photos on the said web page (20) or the other photo files on other web pages, the user must repeat the said five actions by continuously shifting or operating in different windows or on different web pages for gradually downloading all the requested photo files. Therefore, the downloading procedures of the traditional Internet browser are not only irksome, but also subject to significantly consuming the user's time as well as energy and that obviously does not meet the requirement of a humanistic operation.

### SUMMARY OF THE INVENTION

In view of the significant consumption of the user's time and energy caused by the irksome procedures of the traditional Internet browser in downloading a photo from a web page. The inventor of the present invention provides a method of automatically downloading the photo from a web page. The said method has a photo collector plugged in a web page browser installed in a computer. After the said browser opens a web page on-line, a photo selection button disposed on the said photo collector is activated to make the said photo collector recognize all the thumbnails on the said web page and available for downloading the photo as well as to respectively generate a click mark on the rim of the said thumbnails for the user to click on the photo to be downloaded according to the need.

Therefore, one of the objectives of the present invention is to activate a photo downloading button disposed on the said photo collector after all the said marks have been clicked to make the said photo collector, based on the clicked thumbnails, automatically go to the storage locations corresponding to the photos at the website of the said web page and sequentially download the photos to be viewed. This method makes the operating procedure of photo downloading easier and further meet the humanistic requirement.

Another objective of the present invention is to dispose a select-all button on the said photo collector; when being activated, the select-all button makes the said photo collector automatically recognize all the thumbnails on the said web page and available for downloading the photos, go to the website of the said web page and sequentially download all the photos based on the storage locations of the photos corresponding to the thumbnails.

For enabling a further understanding of the present invention, the brief description of the drawings below is followed by the detailed description of the preferred embodiment.

### BRIEF DESCRIPTION OF THE DRAWINGS

FIG. 1 is a schematic drawing of a web page screen opened by a traditional Internet browser.

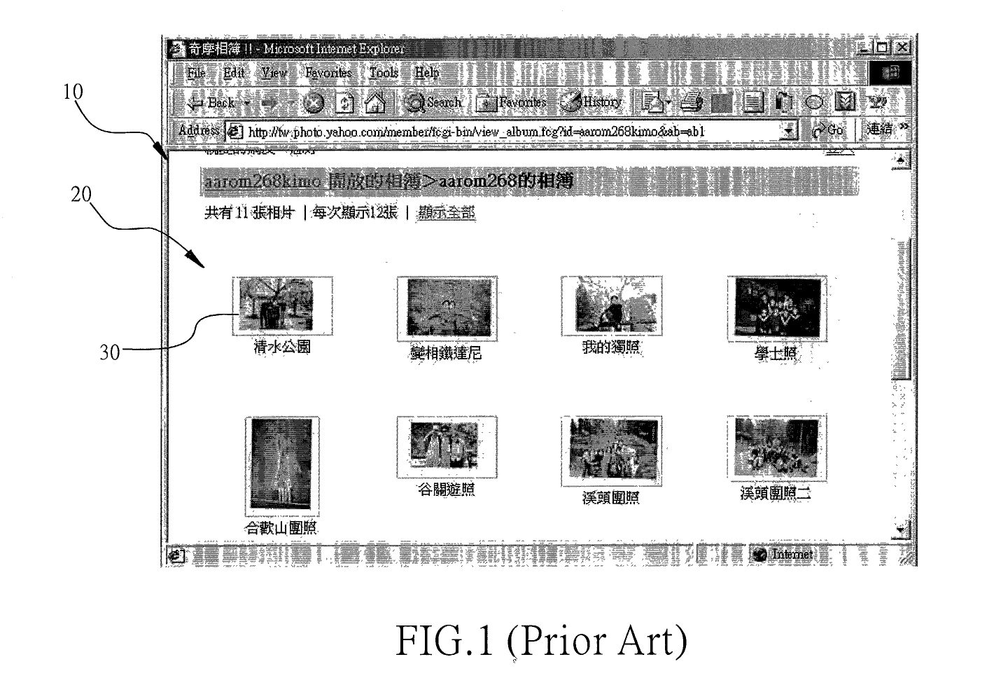

FIG. 2 is a schematic drawing of a screen showing the clicking on the thumbnail on the web page indicated in FIG. 1.

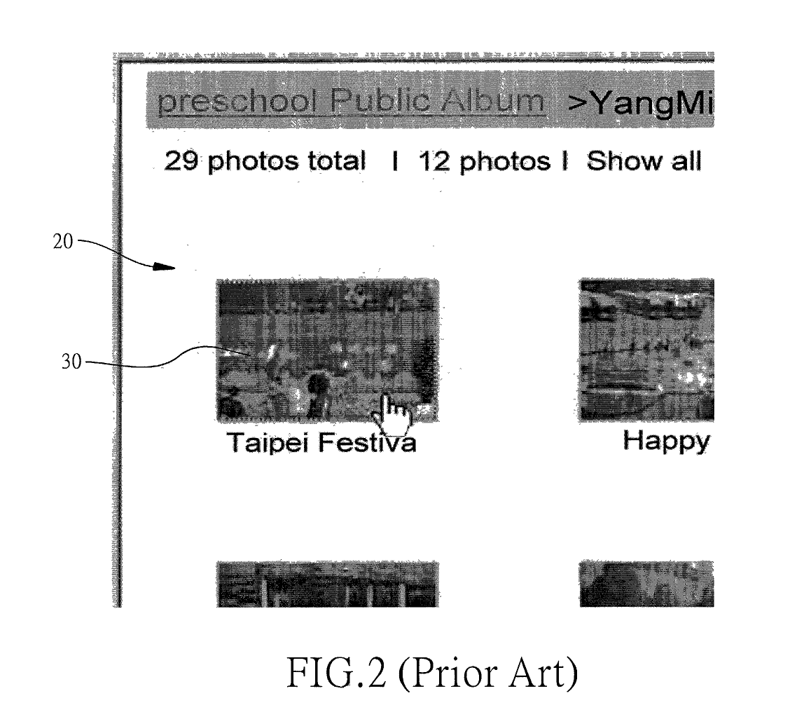

FIG. 3 is a schematic drawing of a screen showing the downloading of a photo from the network in accordance with the thumbnail indicated in FIG. 2.

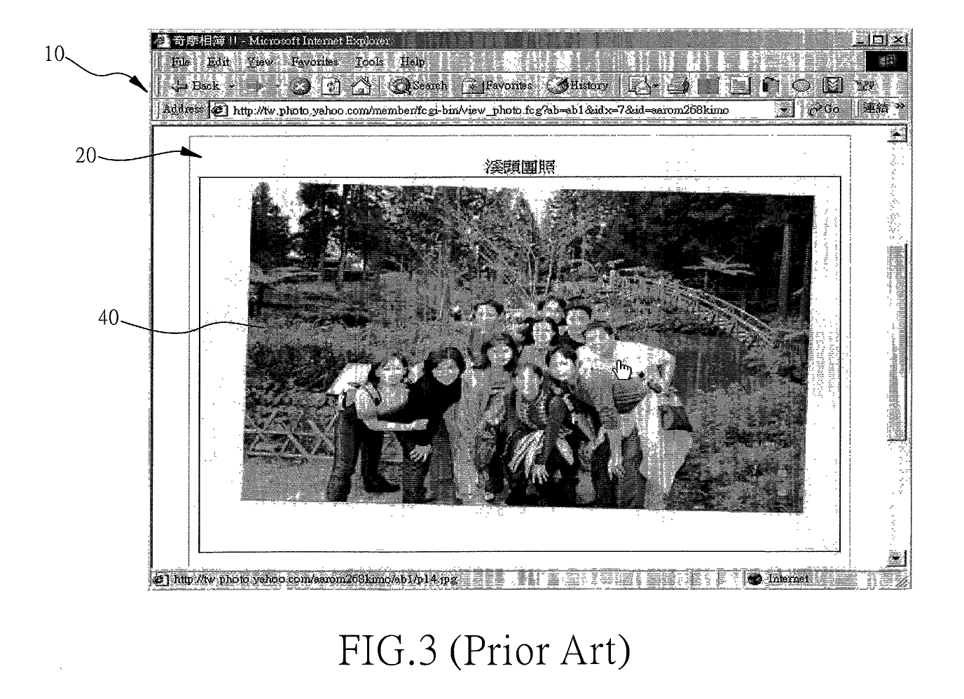

FIG. 4 is a schematic drawing of a screen showing the save conduction in accordance with the photo indicated in FIG. 3.

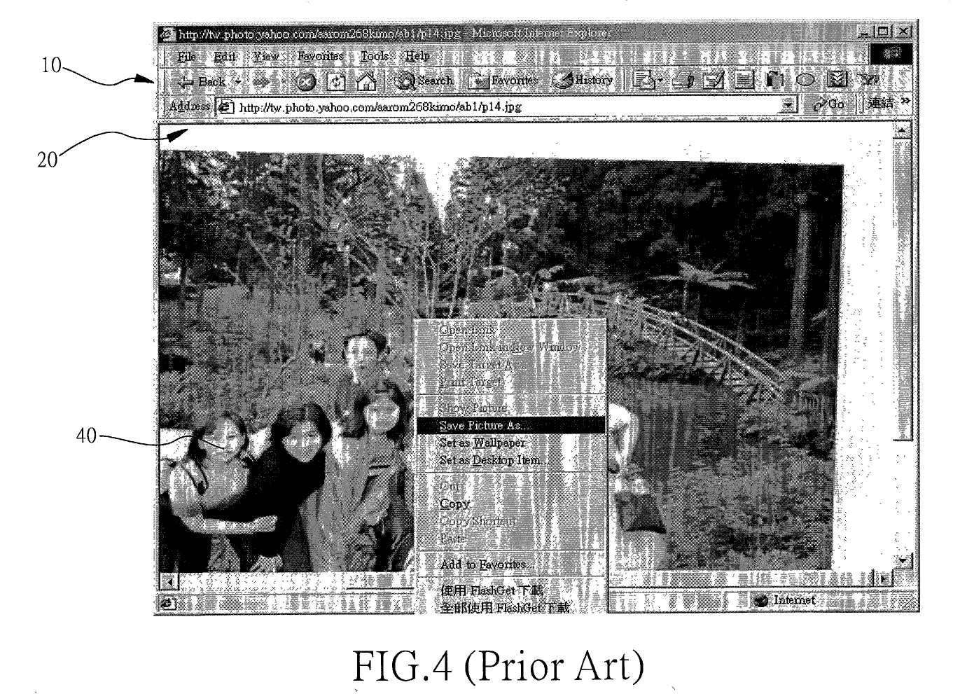

FIG. 5 is a schematic drawing of a screen showing the setting up of a file for saving the photo indicated in FIG. 3.

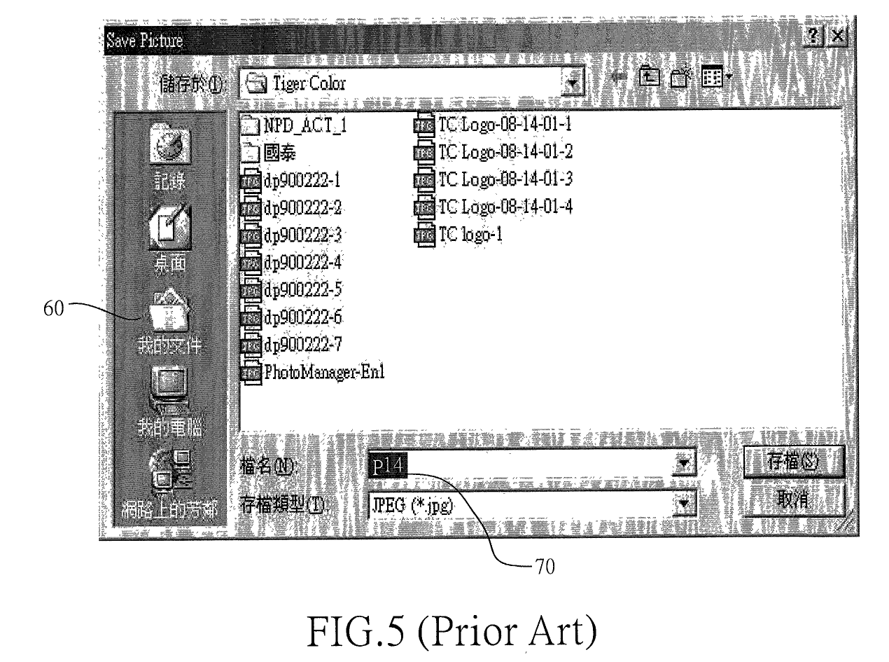

FIG. 6 is a schematic drawing of a screen showing the plugging of a photo collector in the function press key in one of the exemplary embodiments of the present invention.

FIG. 7 is a schematic drawing of the operation flow of the present invention.

FIG. 8 is a schematic drawing of a screen showing that the said photo collector of the present invention is activated.

FIG. 9 is a schematic drawing of a screen showing that the said photo collector of the present invention generates a click-on mark on the rim of the said thumbnails.

FIG. 10 is a schematic drawing of another screen showing that the said photo collector of the present invention is activated.

FIG. 11 is a schematic drawing of a screen showing that click-on marks of the thumbnails indicated in FIG. 9 are clicked.

FIG. 12 is a schematic drawing of a screen showing that a window of the photo browser of an image processing software of the present invention is displaying a photo.

FIG. 13 is a schematic drawing of a screen that the image processing software of the present invention is displaying a photo on a desktop thereof.

### DETAILED DESCRIPTION OF THE PREFERRED EMBODIMENTS

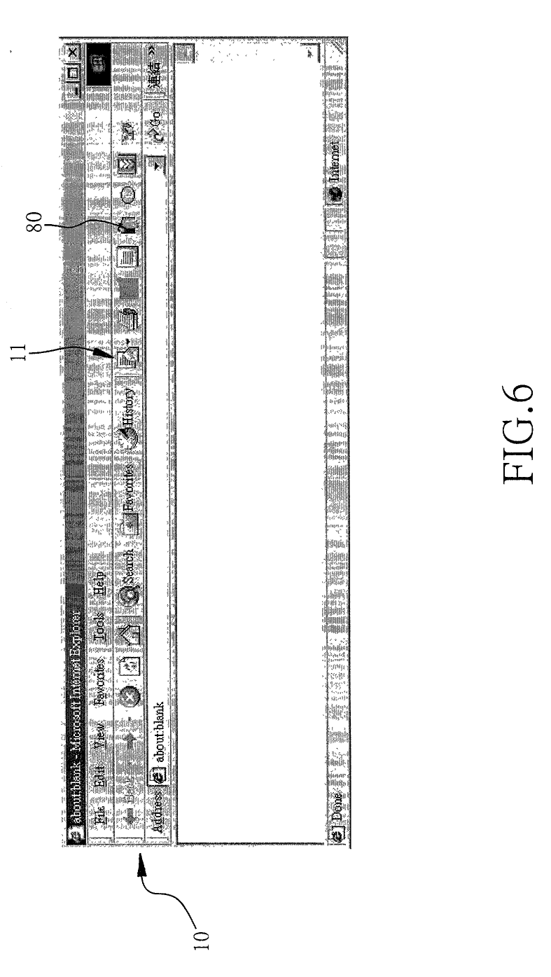

Referring to FIG. 6˜13, the present invention relates to a processing method of an image processing software, more especially to an image processing software installed in a computer and comprising a photo collector (80) therein to be plugged in the screen of a web page browser (10) installed in the said computer. After selecting the said web page browser (10) to get on-line and opening a web page (20), the user can freely browser the contents of pictures and words thereon. Furthermore, the user can use a mouse (or other input device such as a sensing pen of a digital drawing board) connected with the said computer to click on a photo selection button (81) disposed on the said photo collector (80) to make the said photo collector (80) recognize all the thumbnails (30) available on the said web page (20) for downloading the photos and respectively generate a click-on mark (82) on the rim of all the thumbnails (30) for the user to click on the photos to be downloaded according to the actual need.

In the present invention, after using the said mouse to click on the said marks (82) for photos to be downloaded, the user can activate a photo downloading button (83) disposed on the said photo collector (80) through the said mouse to make the said photo collector (80), based on the clicked thumbnails (30), automatically go to the storage locations of the photos corresponding to the said thumbnails (30) at the website of the said web page (20) to sequentially download the requested photos and automatically save them in the save equipment of the computer for later access at any time.

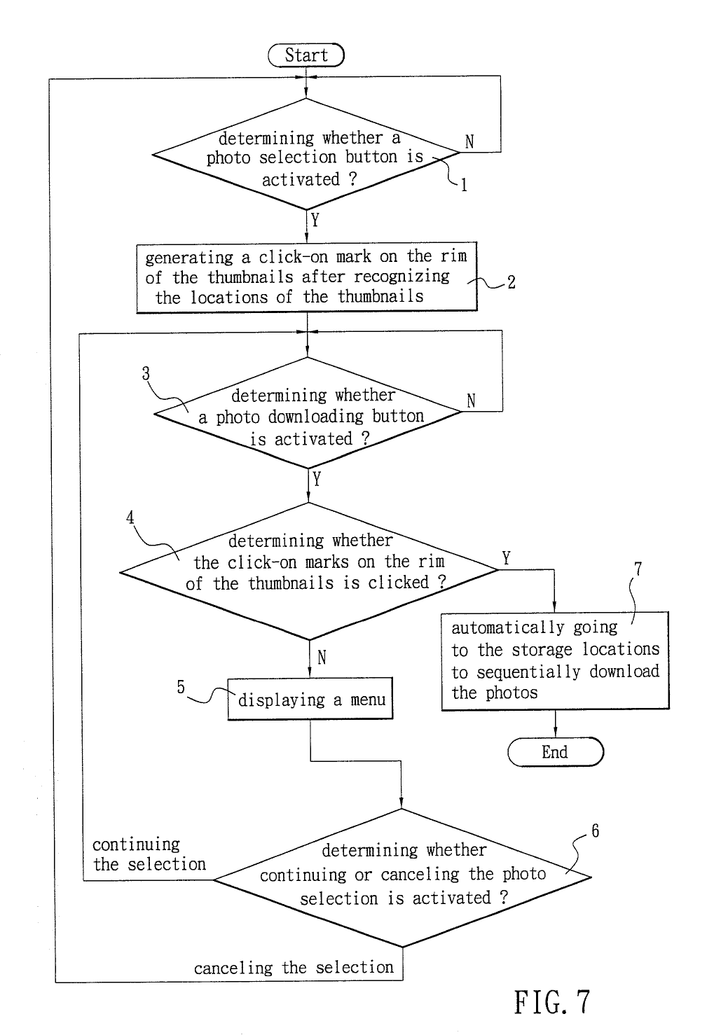

In one of the preferred embodiments of the present invention, after being installed in the said computer, the said photo collector (80) comprised in the said image processing software is plugged in the function press button (11) of the said web page browser (10), as shown in FIG. 6; thereby, after the user uses the said web page browser (10) to get on-line and activates a web page (20), the contents of pictures and words on the web page (20) can be displayed on the screen of the said computer. At this time, referring to FIG. 7, the said image processing software, based on the user's indication, goes to the website of the said web page (20) to automatically download the requested photos in the following processing steps:

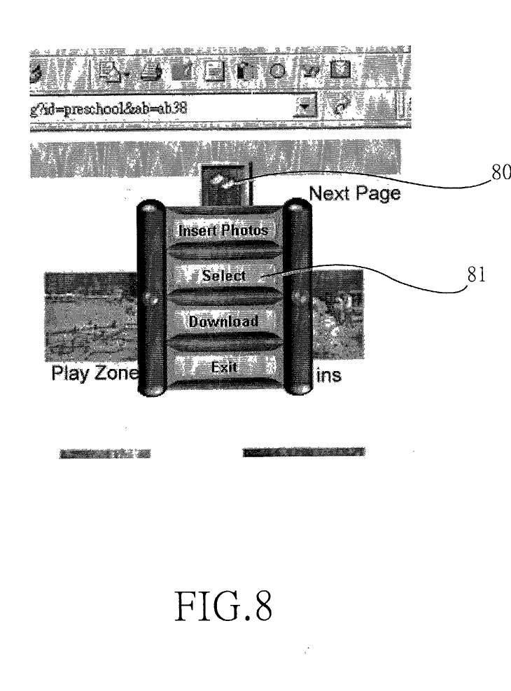

1. First, referring to FIG. 8, the said software detects and determines whether a photo selection button (81) disposed on the said photo collector (80) is activated or not; if yes, it continues the following steps; otherwise, it continues detecting the said photo selection button (81);

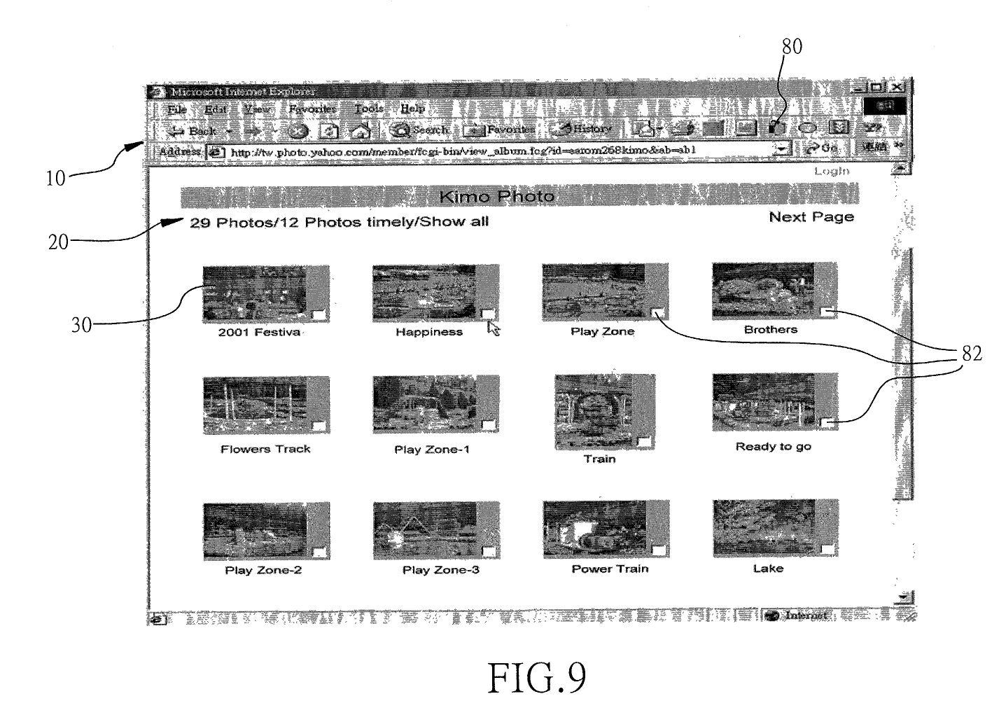

2. The said software detects all the thumbnails (30) on the said web page (20) available for downloading the photos and respectively generates a click-on mark (82) (a small block in the said embodiment) on the rim of the thumbnails (30) after recognizing the locations of the thumbnails (30), referring to FIG. 9, to allow the user to click on and download the photos according to the actual need;

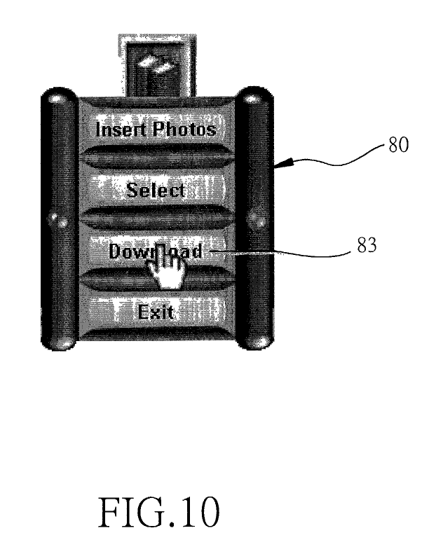

3. Referring to FIG. 10, the said software detects and determines whether a photo downloading button (83) disposed on the said photo collector (80) is activated or not; if yes, it continues the following steps; otherwise, it continues to detect the said photo downloading button (83);

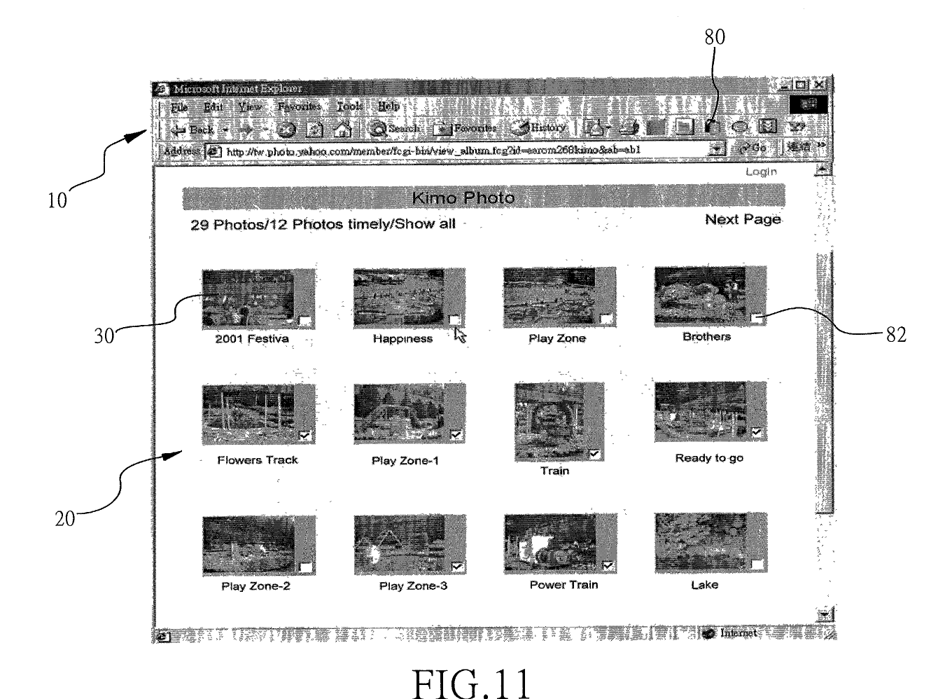

4. The said software detects and determines whether the click-on marks (82) on the rim of the thumbnails (30) on the said web page (20) is clicked or not, referring to FIG. 11; if yes, the said software reads and accesses all the storage locations concealed in the clicked thumbnails (30) and corresponding to the photos, automatically goes to the storage locations of the photos at the website of the said web page (20) and sequentially downloads all the photos to be viewed; otherwise, it continues the following steps;

5. The software displays a menu which includes at least a menu item for the user to continue selecting the photo and a menu item for the user to cancel the photo selection;

6. The software determines the clicked menu item in the menu, if the menu item for continuing the photo selection is activated, it returns to step 3; if the menu item for canceling the photo selection is activated, it returns to step 1;

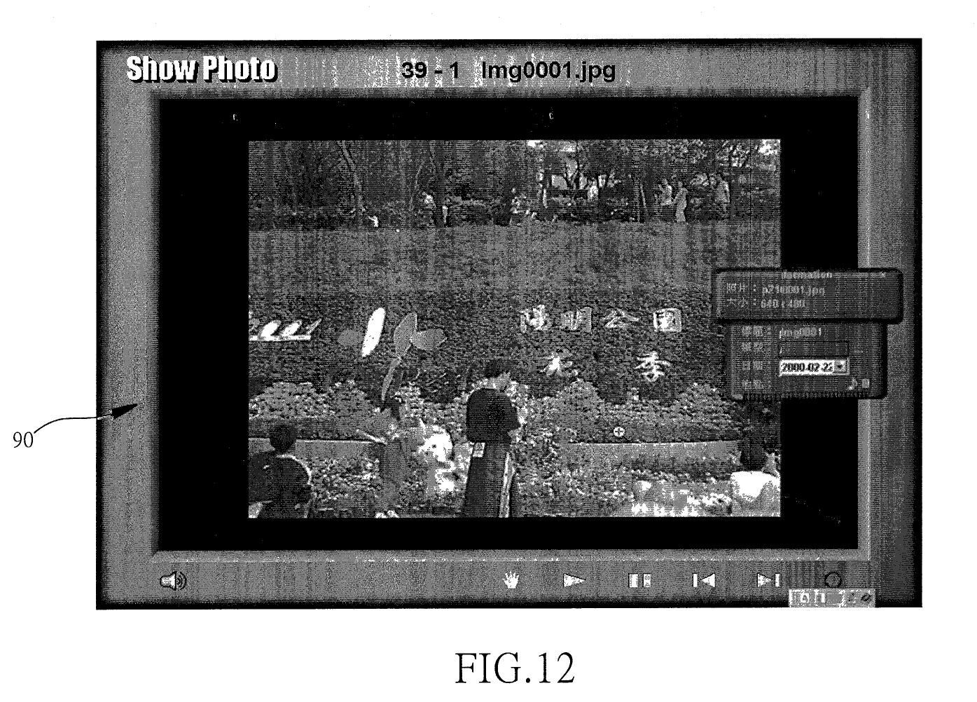

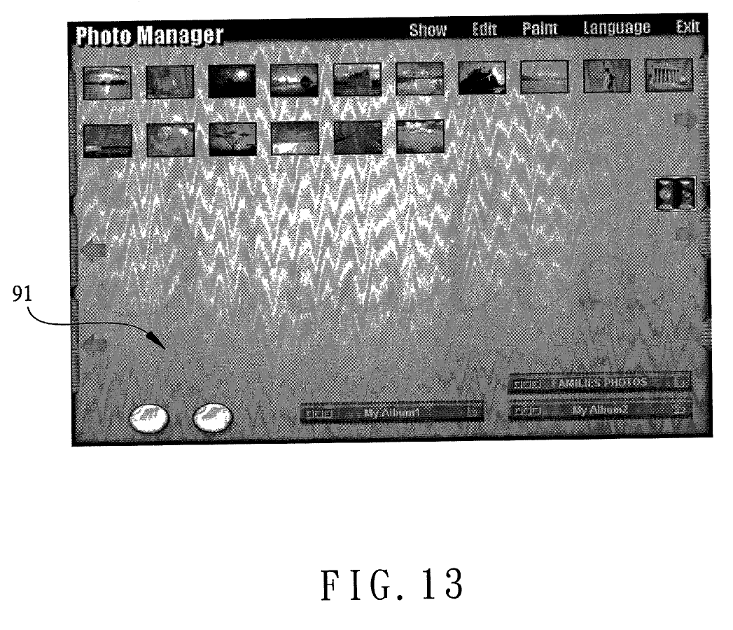

7. The software automatically save the sequentially downloaded photos in the save equipment of the computer for later access at any time or displaying the photos in the photo browsing window (90) of the said image processing software, referring to FIG. 12, or on the desktop (91) of the said image processing software, referring to FIG. 13. for enlarging the details, album categorization or executing image editing.

Accordingly, the present invention enables the user to utilize the said photo collector cooperated with the traditional web page browser to easily and fast download photos from the web page. Taking a web page with twenty-five thumbnails for example, by using the traditional web page browser to download all of the twenty-five photos, the user needs to repeat five downloading procedures for each of the photos. The total number of the irksome downloading actions is one hundred and twenty-five. However, by adapting the present invention, after browsing all of the twenty-five illustrations, the user only needs to use the mouse to click the click-on marks on the rim of the thumbnails to activate the said photo downloading button to make the said photo collector, based on the clicked thumbnails, automatically go to the corresponding storage locations of the photos at the website of the said web page, sequentially download all the photos and automatically save them. It only takes few actions to easily accomplish downloading all the photos on the said web page and thus tremendously reduces the time and energy required for downloading the photos and thereby makes the downloading operation meet the humanistic requirement more.

In another embodiment of the present invention, a select-all button is disposed on the said photo collector; when the said select-all button is activated, it makes the said photo collector automatically recognize all the thumbnails on the said web page and available for downloading the photos, and automatically go to the website of the web page and sequentially download all the photos based on the storage locations of the photos corresponding to the thumbnails.

It is of course to be understood that the embodiment described herein is merely illustrative of the principles of the invention and that a wide variety of modifications thereto may be effected by persons skilled in the art without departing from the spirit and scope of the invention as set forth in the following claims.

What is claimed is:

1. A method of automatically downloading the photos from a web page, the method relates to a photo collector comprised in an image processing software installed in a computer and plugged in a screen of a web page browser disposed in the said computer for conducting the following processing toward the photos on the said web page after the web page browser is on-line and opens a web page:
recognizing all the thumbnails on the said web page available for downloading the photos as well as respectively generating a click-on mark on the rim of the said thumbnails, when a photo selection button disposed on the said photo collector is clicked by a input device connected with a computer;
automatically going to the storage locations of the photos corresponding to the thumbnails at the website of the web page to sequentially download all the photos based on the thumbnails corresponding to the clicked click-on marks, when a photo downloading button disposed on the said photo collector is clicked by an input device.

2. A method of automatically downloading the photos from a web page according to claim 1, wherein as the said photo selection button is determined not being activated, continuously detecting the said photo selection button.

3. A method of automatically downloading the photos from a web page according to claim 1, wherein as the said photo downloading button is determined not being activated, continuously detecting the said photo downloading button.

4. A method of automatically downloading the photos from a web page according to claim 1, wherein as the said photo downloading button is determined being clicked by the said input device, but none of the click-on marks on the rim of the said thumbnails is clicked, displaying a menu including a menu item for continuing the photo selection and a menu item for canceling the photo selection.

5. A method of automatically downloading the photos from a web page according to claim 4, wherein as the menu item of continuing the photo selection is activated, returning to the previous step to continue detecting whether the said photo downloading button is activated or not.

6. A method of automatically downloading the photos from a web page according to claim 4, wherein as the menu item of canceling the photo selection is activated, returning to the previous step to continue detecting whether the said photo selection button is activated or not.

7. A method of automatically downloading the photos from a web page according to claim 1, wherein the web page browser automatically saves the photo downloaded sequentially in a save equipment of the said computer for later access at any time.

8. A method of automatically downloading the photos from a web page according to claim 1, wherein the photo collector automatically displays the said sequentially downloaded photos in a photo browsing window of the said image processing software for enlarging the details.

9. A method of automatically downloading the photos from a web page according to claim 1, wherein the photo collector automatically displays the said sequentially downloaded photos on a desktop of the said image processing software for album categorization or executing image editing.

10. A method of automatically downloading the photos from a web page according to claim 1, wherein a select-all button is disposed on the said photo collector; when the said select-all button is activated, it makes the said photo collector automatically recognize all the thumbnails on the said web page and available for downloading the photos, and go automatically to the website of the web page and sequentially download all the photos based on the storage locations of the photos corresponding to the thumbnails.
